(19) United States
(12) Patent Application Publication
(10) Pub. No.: US 2016/0012968 A1
(43) Pub. Date: Jan. 14, 2016

(54) RECEIVER COIL PART AND WEARABLE DEVICE WITH SAME

(71) Applicant: POWERWOW TECHNOLOGY INC, Hsinchu County (TW)

(72) Inventor: CHUANG-LUNG CHIU, Hsinchu County (TW)

(21) Appl. No.: 14/795,993

(22) Filed: Jul. 10, 2015

(30) Foreign Application Priority Data
Jul. 11, 2014 (TW) 103123940

(51) Int. Cl. H01F 38/14; H01F 27/28; H02J 7/02; H01F 1/04

(52) U.S. Cl. CPC H01F 38/14; H01F 1/04; H01F 27/2804; H02J 7/025

(57) ABSTRACT

A receiver coil part is applied to an open-ring or close-ring carrier part of a wearable device. The receiver coil part includes a contiguous conductive wire. The contiguous conductive wire can generate an induced current. Moreover, some of the conductive segments of the receiver coil part are selectively coated, covered or enclosed by a magnetic structure. Consequently, the magnetic field lines generated by the conductive segments are shielded by the magnetic structure. Moreover, the wearable device with the receiver coil part can be placed on a charging pad more flexibly.

### FIELD OF THE INVENTION

The present invention relates to a wireless charging technology, and more particularly to a receiver coil part for a wireless charging technology and the applications thereof.

### BACKGROUND OF THE INVENTION

In recent years, wearable devices are popular commodities. Especially, the wearable devices with the wireless charging function are the mainstreams in designing the wearable devices. For receiving more magnetic field lines, the coils used in the wireless charging technology should have a ring-shaped profile. Take the applications on a watch as an example. It is an intuitive way to arrange the receiver coil along the strap of the watch in order to integrate the ring-shaped coil for the wireless charging application. However, for facilitating the user to wear the watch, the watch strap has an open-ring design or the size of the watch strap is adjustable. Moreover, the open-ring watch strap or the size-adjustable watch strap is usually equipped with a buckle. Under this circumstance, even if the receiver coil is formed on the watch strap, the receiver coil is not ring-shaped because the watch strap has the open-ring design. Otherwise, if the watch strap has a close-ring design, it is difficult for the user to wear the watch.

For removing the above drawbacks, Taiwan Patent Publication No. 201303739 discloses a bracelet ornament. The bracelet ornament comprises a wound-wire close antenna for receiving data or acting as a wireless charging receiver coil. This design can be applied to the open-ring bracelet. However, in case that the wound wire antenna is used as the wireless charging receiver coil, some drawbacks occur. For example, as shown in FIG. 8 of Taiwan Patent Publication No. 201303739, the bracelet ornament has to stand upright on a charging pad with a strap surface thereof contacting the charging pad. However, the way of allowing the bracelet ornament or the watch to stand upright on a charging pad cannot comply with the usual practices of most users.

When the usual practices of placing the wearable device and the charging efficacy are taken into consideration, the above coil design needs to be further improved.

### SUMMARY OF THE INVENTION

An object of the present invention provides a receiver coil part for a wearable device. The receiver coil part is disposed within an elongated carrier part. The conductive segments (or trace segments) of the receiver coil part are reciprocally distributed within the carrier part in a staggered form or a non-staggered form. Consequently, the receiver coil part can be applied to a wearable device with an open-ring design or a close-ring design. Moreover, during the wireless charging process, the wearable device with the receiver coil part lies flat on a transmitter device according to the usual practices of most users.

Another object of the present invention provides a receiver coil part for a wearable device. A magnetic structure is distributed in at least a portion of the receiver coil part for shielding the magnetic field lines that are generated by the induced current during the wireless charging process. When the wearable device with the receiver coil part is wirelessly charged, the flat placement of the wearable device can comply with the usual practices of most users. Moreover, due to the flat placement, the wireless charging efficiency is satisfied.

In accordance with an aspect of the present invention, there is provided a receiver coil part for generating an induced current in response to magnetic resonance or magnetic induction. The receiver coil part includes a contiguous conductive wire and at least one magnetic structure. The contiguous conductive wire includes at least one first conductive segment and at least one second conductive segment. Across a cross section of the contiguous conductive wire containing the first conductive segment and the second conductive segment, the direction of the induced current flowing through the first conductive segment and the direction of the induced current flowing through the second conductive segment are opposite to each other. The at least one magnetic structure is arranged between the first conductive segment and the second conductive segment.

In an embodiment, the magnetic structure is formed on a portion or an entire of either an outer surface of the first conductive segment or an outer surface of the second conductive segment, or the magnetic structure is fixed between a portion or an entire of the first conductive segment and a portion or an entire of the second conductive segment.

In an embodiment, the magnetic structure at least contains a permeability material selected from manganese-zinc ferrite, nickel-zinc ferrite, nickel-copper-zinc ferrite, manganese-magnesium-zinc ferrite, manganese-magnesium-aluminum ferrite, manganese-copper-zinc ferrite, cobalt ferrite, nickel-iron alloy, iron-silicon alloy, iron-aluminum alloy, copper, aluminum, iron, nickel or a combination thereof.

In an embodiment, the contiguous conductive wire is a metallic conductive wire, an alloy conductive wire, a conductive polymeric wire, a conductive trace on a rigid printed circuit board or a conductive trace on a flexible printed circuit board.

In accordance with another aspect of the present invention, there is provided a receiver coil assembly. The receiver coil assembly includes the above-mentioned receiver coil part and a carrier part. The receiver coil part is accommodated within the carrier part.

In an embodiment, the magnetic structure is formed in the carrier part, the magnetic structure is formed on a portion or an entire of either an outer surface of the first conductive segment or an outer surface of the second conductive segment, the magnetic structure is sheathed around either the first conductive segment or the second conductive segment, and/or the magnetic structure is fixed between a portion or an entire of the first conductive segment and a portion or an entire of the second conductive segment.

In an embodiment, the contiguous conductive wire is a metallic conductive wire, an alloy conductive wire, a conductive polymeric wire, a conductive trace on a rigid printed circuit board or a conductive trace on a flexible printed circuit board.

In accordance with a further aspect of the present invention, there is provided a wearable device. The wearable device includes the above-mentioned receiver coil part, a carrier part and a processing circuit. The receiver coil part is accommodated within the carrier part. Moreover, two ends of the contiguous conductive wire are connected with the processing circuit.

In an embodiment, the processing circuit is disposed within the carrier part.

From the above descriptions, the present invention provides a receiver coil part. The receiver coil part is applied to an open-ring or close-ring carrier part of a wearable device. The receiver coil part includes a contiguous conductive wire. The contiguous conductive wire can generate an induced current. Moreover, some of the conductive segments of the receiver coil part are selectively coated, covered or enclosed by a magnetic structure. Consequently, the magnetic field lines generated by the conductive segments are shielded by the magnetic structure. Moreover, the wearable device with the receiver coil part can be placed on the charging pad more flexibly.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is schematic top view illustrating a receiver coil assembly according to an embodiment of the present invention;

FIG. 2 is a schematic cross-sectional view illustrating a first example of the magnetic structure/material/substance/layer distributed in the receiver coil assembly of the present invention;

FIG. 3 is a schematic cross-sectional view illustrating a second example of the magnetic structure/material/substance/layer distributed in the receiver coil assembly of the present invention;

FIG. 4 is a schematic cross-sectional view illustrating a third example of the magnetic structure/material/substance/layer distributed in the receiver coil assembly of the present invention;

FIG. 5 is a schematic cross-sectional view illustrating a fourth example of the magnetic structure/material/substance/layer distributed in the receiver coil assembly of the present invention;

FIG. 6 schematically illustrates some wearable devices with the receiver coil assemblies during the wireless charging process; and

FIG. 7 schematically illustrates some wearable devices with another embodiment of a receiver coil assemblies during the wireless charging process.

### DETAILED DESCRIPTION OF THE PREFERRED EMBODIMENT

In this context, an elongated structure is expressed by an orthogonal X-Y-Z coordinate system. That is, the extending length of the elongated structure along the X-axis direction is much larger than the extending lengths of the elongated structure along the Y-axis direction and the Z-axis direction, and the extending length of the elongated structure along the Z-axis direction is larger than the extending length of the elongated structure along the Y-axis direction. It is noted that the concept of the present invention is not restricted to the elongated structure. That is, the concept of the present invention can be applied to a non-elongated structure. For example, the non-elongated structure includes a square structure, a circular structure or any other irregular structure.

For clearly understanding the distribution of the receiver coil part, the receiver coil part in some embodiment will be illustrated by referring to conductive segments of the receiver coil part. In particular, some conductive segments substantially extend along the X-axis direction, and the other conductive segments substantially extend along the Z-axis direction. The junctions between adjacent conductive segments are bent at a specified angle or have curvy shapes. Moreover, these conductive segments are straight lines or curvy lines in a staggered form or a non-staggered form. The two end of a contiguous conductive wire of the receiver coil part are connected with a circuit or electronic part or other components. For a clarification purpose, a void space is intervened between every two adjacent conductive segments as shown in the drawings. In practice, when the receiver coil part is applied to the wearable device, the void space between the adjacent conductive segments is very small or even the adjacent conductive segments are in contact with each other.

In an embodiment, the receiver coil part is a metallic conductive wire, an alloy conductive wire or a conductive polymeric wire. The alloy conductive wire or the conductive polymeric wire can be directly accommodated within a covering member of the wearable device. In another embodiment, the receiver coil part is a conductive trace on a rigid printed circuit board (PCB) or a conductive trace on a flexible printed circuit board (FPC). Under this circumstance, the conductive trace is firstly formed on a base plate (e.g., a substrate of the rigid or flexible printed circuit board), and then covered by a covering member. In the following embodiments, the cross section of the receiver coil part is expressed with a specified shape (e.g., a rectangular shape). It is noted that the shape of the cross section is not restricted. For example, the cross section of the receiver coil part may have a cylindrical shape, a trapezoid shape or any other appropriate shape.

The magnetic structure used herein is also referred as a magnetic material, a magnetic substance or a magnetic layer. The magnetic structure/material/substance/layer may be formed on or close to the outer surfaces of the conductive segments of the receiver coil part by an appropriate method such as an adsorption method, a painting method, a coating method, an adhering method or an implanting method. For each conductive segment, the magnetic structure can be distributed on at least a portion or the entire of the outer surface of the conductive segment. That is, the magnetic structure is formed on a specified portion or the entire of each conductive segment according to the design or practical requirement. Consequently, the wireless charging efficiency of the magnetic induction or the magnetic resonance will be effectively enhanced. The magnetic structure contains a permeable material. Preferably but not exclusively, the permeable material is selected from manganese-zinc ferrite, nickel-zinc ferrite, nickel-copper-zinc ferrite, manganese-magnesium-zinc ferrite, manganese-magnesium-aluminum ferrite, manganese-copper-zinc ferrite, cobalt ferrite, nickel-iron alloy, iron-silicon alloy, iron-aluminum alloy, copper, aluminum, iron, nickel or a combination thereof. In addition to the magnetic material, the magnetic structure/material/substance/layer may further contain other non-permeable materials.

The receiver coil part of the present invention can be applied to a wearable device. The wearable device is fixed on the body or the limb of the user for facilitating the user to carry. Moreover, the wearable device is used by the user when fixed on the body or the limb of the user. An example of the wearable device included but is not limited to a watch, a bracelet, a ring, an armband or a pair of glasses.

In the following embodiments, the receiver coil part and a processing circuit or electronic part are integrated into the elongated structure. An example of the processing circuit includes but is not limited to a receiver circuit, another circuit or another electronic component. Moreover, the processing circuit may cooperate with other component of the wearable device (e.g., a chip, an image pickup part or a control panel). In the following drawings, the processing circuit or the electronic component is indicated by a single part. It is noted that the processing circuit or the electronic component may include plural separate portions or the processing circuit or the electronic component may be integrated into a one-piece component.

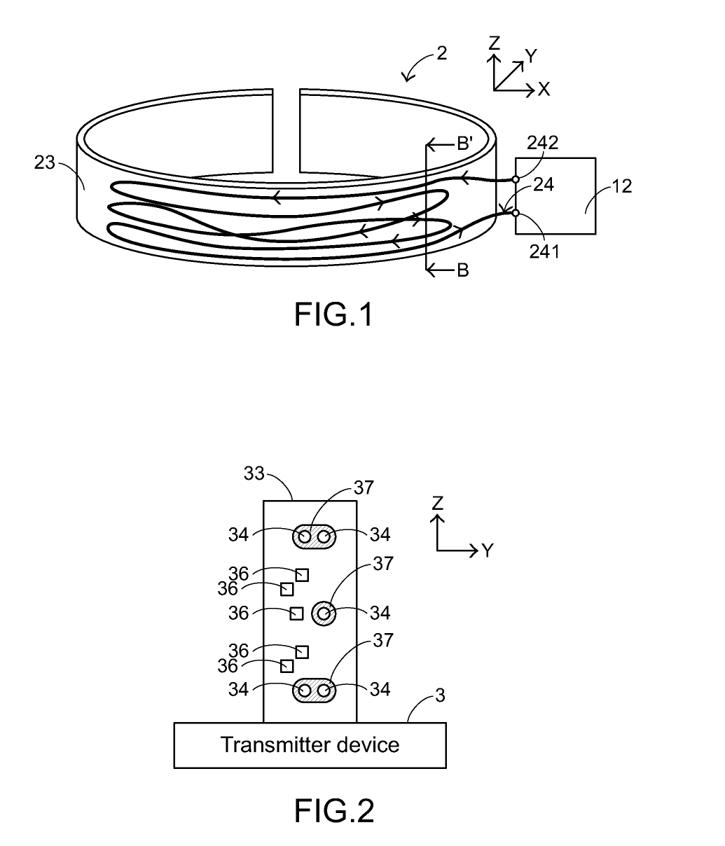

FIG. 1 is schematic top view illustrating a receiver coil assembly according to an embodiment of the present invention. FIGS. 2-5 are schematic cross-sectional views illustrating some examples of the magnetic structure/material/substance/layers distributed in the receiver coil assembly of the present invention. It is noted that the distribution of the magnetic structure/material/substance/layers and the wiring pattern of the receiver coil part are not restricted to those shown in the drawings.

As shown in FIG. 1, the receiver coil assembly 2 comprises a carrier part 23 and a coil part. In this embodiment, the coil part comprises a contiguous conductive wire 24. The contiguous conductive wire 24 has two ends 241 and 242. A circuit or electronic part 12 is connected between the two ends 241 and 242 of the contiguous conductive wire 24. Moreover, the circuit or electronic part 12 and the coil part may be collaboratively covered by the carrier part 23. For example, the circuit or electronic part comprises a processing circuit and an electronic component. Moreover, the circuit or electronic part is located at a proper position of the carrier part 23 (e.g., a middle region or a terminal region of the carrier part). The contiguous conductive wire 24 comprises plural conductive segments. The plural conductive segments are reciprocally distributed within the carrier part 23. These conductive segments are distributed in the carrier part 23 in a staggered form or a non-staggered form. In an embodiment, the carrier part 23 has an open-ring design. In case that the carrier part 23 with the open-ring design is equipped with a fastening structure or other appropriate structure, the carrier part 23 has a close-ring design. In another embodiment, the carrier part 23 has a close-ring design inherently. Moreover, the material of the carrier part 23 is any material appropriate for the wearable device as long as the material of the carrier part 23 is isolated from the coil part.

FIG. 2 is a schematic cross-sectional view illustrating a first exemplary receiver coil assembly and a transmitter device. The receiver coil assembly of FIG. 2 is taken along the cross section B-B′ of FIG. 1. As shown in FIG. 2, plural first conductive segments 34 and plural second conductive segments 36 of the contiguous conductive wire are disposed within the carrier part 33. In FIG. 2, the circular dots and the square dots represent opposite directions of the induced current. It is noted that the cross-sectional shapes of the conductive segments are not limited by the shapes of these dots shown in the drawings. The plural first conductive segments 34 and the plural second conductive segments 36 may be arranged side by side or disorderly arranged. The arrangement and number of the conductive segments are not restricted to those shown in FIG. 2. In accordance with a feature of the present invention, a magnetic structure/material/substance/layer is formed on at least one of the conductive segments with the same current direction. As shown in FIG. 2, the magnetic structure 37 is sheathed or formed around one or more first conductive segments 34. For example, two first conductive segments 34 are jointly sheathed by the magnetic structure 37, or only a single first conductive segment 34 is sheathed by the magnetic structure 37.

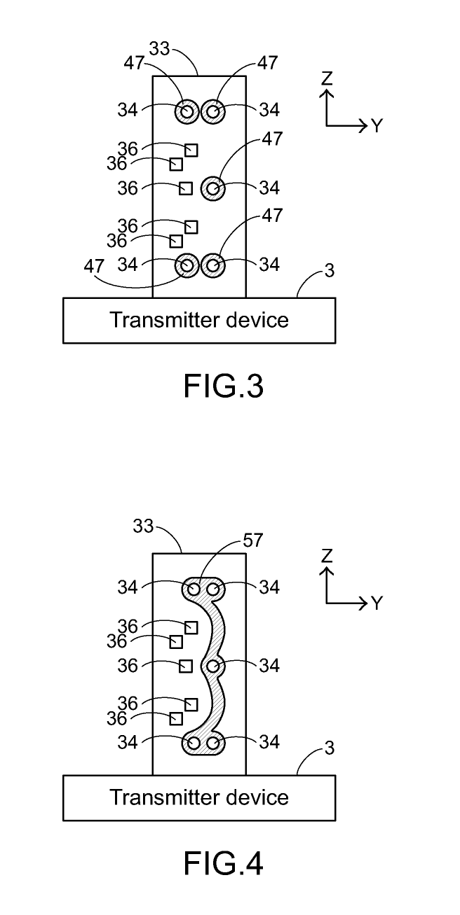

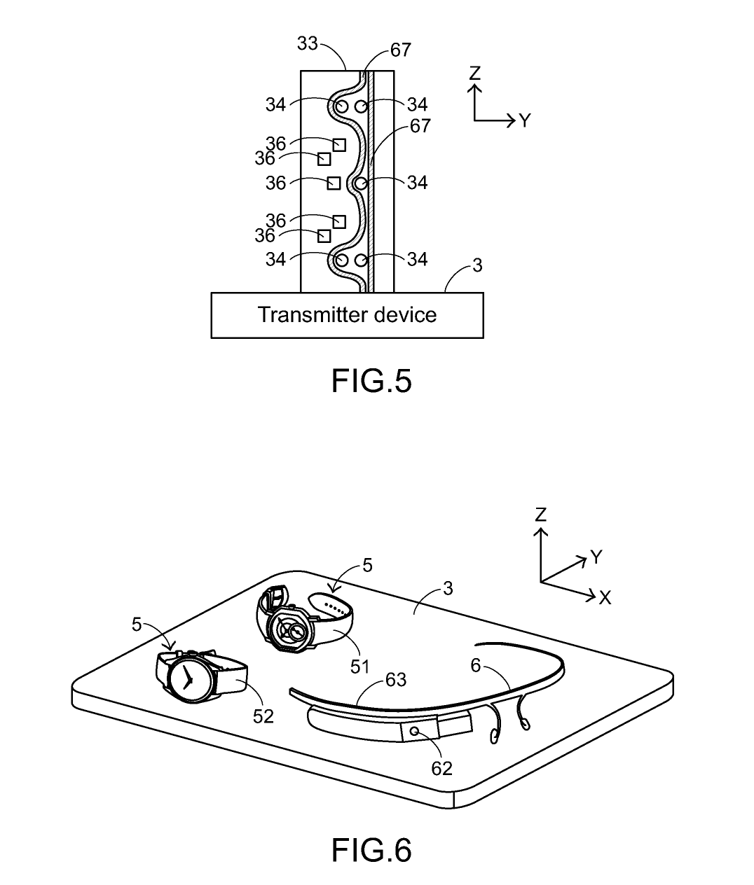

FIGS. 3, 4 and 5 are schematic cross-sectional views illustrating the second, third and fourth exemplary receiver coil assemblies and a transmitter device. In comparison with FIG. 2, each magnetic structure 47 of FIG. 3 is sheathed or formed around one first conductive segment 34. As shown in FIG. 4, all first conductive segments 34 of the carrier part 33 are sheathed by a contiguous magnetic material 57. As shown in FIG. 5, two magnetic layers 67 are attached on each other, and all first conductive segments 34 of the carrier part 33 are arranged between the two magnetic layers 67. By the above distribution configurations, the conductive segments of the receiver coil part with opposite current directions are separated by the magnetic structure. Consequently, the purpose of shielding the magnetic field lines can be achieved.

In the above embodiments, the magnetic structure is only applied to the first conductive segments 34. Alternatively, in some other embodiment, the magnetic structure is only applied to the second conductive segments 36. As long as the conductive segments of the receiver coil with opposite current directions are separated by the magnetic structure/material/substrate/layer, the purpose of shielding the magnetic field lines can be achieved. In other words, the size, position and distribution of the magnetic structure are specially designed such that the induced magnetic field generated by the conductive segments in a specified current direction can be shielded by the magnetic structure. The receiver coil assembly of the present invention can be used as the wireless charging receiver coil of the wearable device. Due to the magnetic structure/material/substance/layer, the wearable device can be placed in a user-friendly manner during the charging process.

From the above descriptions, the magnetic structure is selectively disposed along the conductive wire (or conductive trace) of the charging receiver coil part of the present invention. The induced magnetic field generated by the conductive segments in a specified current direction can be shielded by the magnetic structure, so that the induced magnetic current generated by the conductive segments in the opposite current direction will not be interfered. When the wearable device with the receiver coil part is wirelessly charged, the flat placement of the wearable device can comply with the usual practices of most users. Moreover, by the winding method of the present invention, the receiver coil part of the present invention can be applied to the open-ring wearable device in order to receive the magnetic field lines that are comparable to the close-ring design. Consequently, the wireless charging efficiency is satisfied.

FIG. 6 schematically illustrates some wearable devices with the receiver coil assemblies during the wireless charging process. As shown in FIG. 6, the receiver coil assembly 2 can be applied to a chargeable watch 5 with an open-ring wearing part 51, a chargeable watch 5 with a close-ring wearing part 52, an image pickup part 62 of a wearable glass 6 or a frame 63 or a wearable glass 6. The chargeable watch 5 or the glass 6 is placed on the transmitter device 3 in the placement manner as shown in FIG. 6. The transmitter device 3 lies flat on the X-Y plane. Moreover, the chargeable watch 5 or the glass 6 with the receiver coil assembly 2 of the present invention can lie flat on the transmitter device 3 as the general way of placing general wearable device. Due to the flat placement, the wearable device can be placed on the transmitter device 3 more securely while achieving the desired charging efficiency.

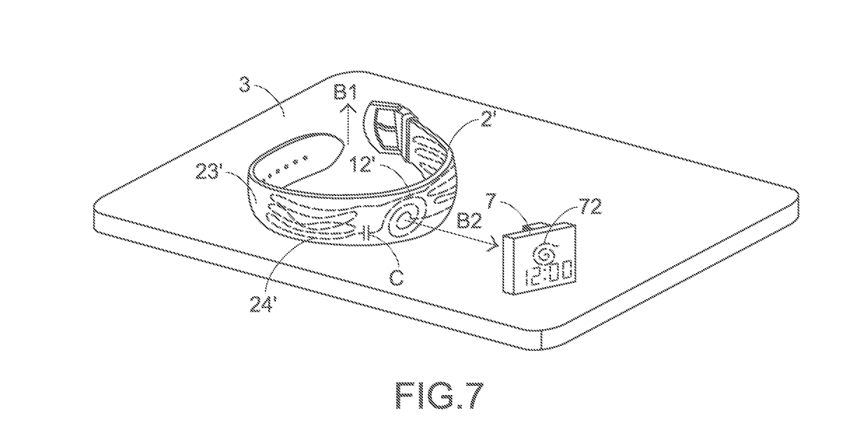

As described above, the circuit or electronic part 12 comprising the processing circuit executes process function or display function. In another embodiment in FIG. 7 as follows, the circuit or electronic part comprises an induction coil 12′. Wherein, when current is induced in the induction coil 12′, the induction coil 12′ is generating a new magnetic field, and the new magnetic field can induce another matching coil for generating current to conduct a wireless charging process.

As shown in FIG. 7, the receiver coil assembly 2′ comprises a carrier part 23′ and the induction coil 12′, wherein a capacitor C and the induction coil 12′ is series connected between the two ends of the contiguous conductive wire 24′. When the transmitter device 3 is inducing the receiver coil assembly 2′, the contiguous conductive wire 24′ generates current therein corresponding to a first magnetic field B1 in a first direction generated by the transmitter device 3. In the meantime, the induction coil 12′ generates a second magnetic field B2 in a second direction, wherein the second direction is different from the first direction. The main objective of generating the second magnetic field is that, if an electronic device 7 is not in direct electric contact with the receiver coil assembly 2′, the electronic device 7 can be charged in a wireless charging way.

Preferably, the electronic device 7 has a wireless charging receiving coil 72, and the electronic device 7 is capable of being detachably assembled with the receiver coil assembly 2′. Further, when the electronic device 7 is engaging in the receiver coil assembly 2′, the induction coil 12′ is parallel to the wireless charging receiving coil 72. With this arrangement, the electronic device 7 could be wireless charged more efficiently.

Take watch as an example, the receiver coil assembly 2′ could be regard as a watch strap, the electronic device 7 could be regard as a watch dial. When a user would like to put the watch on the transmitter device 3 for charging the watch dial, the most convenient way for user is that the user puts the watch with an upright position on the transmitter device 3, this is, the induction coil 12′ is substantially perpendicular to the upper surface of the transmitter device 3. In other words, the direction of the first magnetic field B1 and the second magnetic field B2 are not parallel but possibly perpendicular with each other. Therefore, the second magnetic field B2 could be provided for the assembled watch dial (electronic device 7) a well-charged configuration.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A receiver coil part for generating an induced current in response to magnetic resonance or magnetic induction, the receiver coil part comprising:
a contiguous conductive wire comprising at least one first conductive segment and at least one second conductive segment, wherein across a cross section of the contiguous conductive wire containing the first conductive segment and the second conductive segment, the direction of the induced current flowing through the first conductive segment and the direction of the induced current flowing through the second conductive segment are opposite to each other; and
at least one magnetic structure arranged between the first conductive segment and the second conductive segment.

2. The receiver coil part according to claim 1, wherein the magnetic structure is formed on a portion or an entire of either an outer surface of the first conductive segment or an outer surface of the second conductive segment, or the magnetic structure is fixed between a portion or an entire of the first conductive segment and a portion or an entire of the second conductive segment.

3. The receiver coil part according to claim 1, wherein the magnetic structure at least contains a permeability material selected from manganese-zinc ferrite, nickel-zinc ferrite, nickel-copper-zinc ferrite, manganese-magnesium-zinc ferrite, manganese-magnesium-aluminum ferrite, manganese-copper-zinc ferrite, cobalt ferrite, nickel-iron alloy, iron-silicon alloy, iron-aluminum alloy, copper, aluminum, iron, nickel or a combination thereof.

4. The receiver coil part according to claim 1, wherein the contiguous conductive wire is a metallic conductive wire, an alloy conductive wire, a conductive polymeric wire, a conductive trace on a rigid printed circuit board or a conductive trace on a flexible printed circuit board.

5. A receiver coil assembly, comprising:
a receiver coil part according to claim 1; and
a carrier part, wherein the receiver coil part is accommodated within the carrier part.

6. The receiver coil assembly according to claim 5, wherein the magnetic structure is formed in the carrier part, the magnetic structure is formed on a portion or an entire of either an outer surface of the first conductive segment or an outer surface of the second conductive segment, the magnetic structure is sheathed around either the first conductive segment or the second conductive segment, and/or the magnetic structure is fixed between a portion or an entire of the first conductive segment and a portion or an entire of the second conductive segment.

7. The receiver coil assembly according to claim 5, wherein the contiguous conductive wire is a metallic conductive wire, an alloy conductive wire, a conductive polymeric wire, a conductive trace on a rigid printed circuit board or a conductive trace on a flexible printed circuit board.

8. A wearable device, comprising:
a receiver coil part according to claim 1;
a carrier part, wherein the receiver coil part is accommodated within the carrier part; and
an electrical processing circuit, wherein two ends of the contiguous conductive wire are connected with the electrical processing circuit.

9. The wearable device according to claim 8, wherein the processing circuit is disposed within the carrier part.

10. A wearable device, comprising:
a receiver coil part according to claim 1;
an induction coil;
a carrier part accommodating the receiver coil part and the induction coil; and
an electronic device having a wireless charging receiving coil, wherein the electronic device is detachably assembled to the carrier part,
wherein two ends of the contiguous conductive wire are connected with the induction coil, when the contiguous conductive wire is generating the current, the induction coil is generating another induced magnetic field to charge the electronic device.

11. The wearable device according to claim 10, wherein the induction coil is substantially parallel to the wireless charging receiving coil of the electronic device.

12. A wearable device, comprising:
a receiver coil part according to claim 1;
an induction coil; and
a carrier part accommodating the receiver coil part and the induction coil;
wherein the two ends of the contiguous conductive wire are connected with the induction coil and a capacitor, when the contiguous conductive wire is generating the current in response to a magnetic field in a first direction generated by a wireless charging transmitter device of the surrounding, in the meantime, the induction coil is generating a magnetic field in a second direction, and the first direction is not parallel to the second direction.
